(19) United States
(12) Patent Application Publication
(10) Pub. No.: US 2015/0086027 A1
(43) Pub. Date: Mar. 26, 2015

(54) METHOD FOR OPERATING A LOUDSPEAKER DEVICE, LOUDSPEAKER DEVICE, AND DEVICE FOR NOISE COMPENSATION

(71) Applicant: Audi AG, Ingolstadt (DE)

(72) Inventors: Markus Moser, Gerolsbach (DE); Rene Korsch, Kirschberg-Saupersdorf (DE)

(73) Assignee: Audi AG, Ingolstadt (DE)

(21) Appl. No.: 14/387,144

(22) PCT Filed: Mar. 9, 2013
(86) PCT No.: PCT/EP2013/000705

§ 371 Date: Sep. 22, 2014

(30) Foreign Application Priority Data
Mar. 23, 2012 (DE) 10 2012 005 893.4

(51) Int. Cl. H04R 3/00

(52) U.S. Cl. CPC H04R 3/00
USPC 381/59

(57) ABSTRACT

In a method for operating a loudspeaker device having at least one loudspeaker, at least one actual membrane state parameter of a membrane of the loudspeaker is detected by a detecting device. An actual membrane state of the membrane based on the following actual membrane state parameters: actual membrane position (x_{actual}), actual membrane speed (v_{actual}) and actual membrane acceleration (a_{actual}), is determined from the at least one detected actual membrane state parameter (x_{actual}, a_{actual}) and is directly used to determine a driving signal (U(t)) that is applied to the voice coil of the loudspeaker. The voice coil is operatively connected to the membrane. A loudspeaker device being operated with this method and a device for noise compensation are also disclosed.

The invention relates to a method for operating a loudspeaker device having at least one loudspeaker, wherein at least one actual membrane state value of a membrane of the loudspeaker is detected by a detecting device. The invention further relates to a loudspeaker device and a device for noise compensation.

Methods of the aforementioned type are known from the prior art. In particular, the use of an electro-dynamic loudspeaker having a voice coil and a membrane as sound source is well known. Such a loudspeaker is used as part of stereo systems, for example in the home, as well as in high-performance car-fidelity systems in the automotive sector. Its essential feature is the conversion of a time-dependent driving signal, which is applied to the loudspeaker or its terminals, into a time-dependent sound level profile, i.e., in particular a pressure, density and velocity profile, which is emitted into the environment of the loudspeaker. The driving signal is normally applied to the voice coil of the loudspeaker, which is operatively connected with the membrane and which displaces the membrane commensurate with the driving signal. The driving signal is generally converted in that a phase shift between the driving signal and the generated sound level is not constant, but is dependent on the frequency. Consequently, the driving signal or its shape, unless it is a pure sine wave, is not completely maintained when being converted into the sound profile. It is therefore typically impossible for the membrane of the loudspeaker to follow a predetermined position, velocity and/or acceleration profile in real time. Instead, only the frequencies in a frequency domain, but not the phase or phase shift, are accurately reproduced. Because the human ear cannot distinguish phases, such a behavior of the loudspeaker, however, is sufficient for many applications.

In order to more precisely convert the driving signal into sound, it is known to detect within the context of the “Motional Feedback” principle an actual membrane state value the membrane of the loudspeaker. Subsequently, this actual membrane state value is used to control the loudspeaker. However, even with this approach, the phase shift between the driving signal and the produced sound changes, generally here also a function of the frequency.

It is therefore an object of the invention to propose a method which does not have the abovementioned disadvantage, but which enables a very precise control of the loudspeaker, wherein in particular the phase shift between the driving signal and the produced sound remains constant even at different frequencies, preferably over the entire frequency spectrum that can be converted with the loudspeaker.

This is achieved by the invention with a method having the features of claim 1. It is provided here that an actual membrane state of the membrane which includes the actual membrane state values actual membrane position, actual membrane velocity and actual membrane acceleration, is determined from the at least one measured actual membrane state value and directly used to determine a driving signal that is applied to voice coil of the loudspeaker that is operatively connected with the membrane. To attain the aforementioned advantages, all three mentioned actual membrane state values, i.e. the actual membrane position, the actual membrane velocity and the actual membrane acceleration are determined from the at least one measured actual membrane state value. The actual membrane position, the actual membrane velocity and the actual membrane acceleration are hereby combined in the actual membrane state, which is then used as an input variable for determining the driving signal. This means that not only a single actual membrane state value or individual values of the actual membrane state values are used to determine the driving signal. Instead, the entire actual membrane state is used, which consists of the three actual membrane state values mentioned above. In this way, a highly accurate conversion of the driving signal is achieved.

For this purpose, for example, in addition to the actual membrane state, an input signal is provided to the loudspeaker device as an input value to determine the driving signal. The driving signal is then an output value. For example, the relationship between the actual membrane state or its actual membrane state values and the driving signal is linear. However, a non-linear relationship may also be contemplated. In addition, the actual membrane state may also have at least one actual pressure, for example, the actual sound pressure behind or in front of the membrane of the loudspeaker, in particular at a specified distance from a rest position of the membrane. Preferably, the actual pressure is determined in front of the membrane as well as behind the membrane. The actual pressure may be determined either by a measurement with a detecting device or alternatively by a calculation using a computational model. The computational model may have as an input variable for example at least one of the actual membrane state values and as an output variable the actual pressure.

According to another embodiment of the invention, the actual membrane position, the actual membrane velocity or actual membrane acceleration may be used as the at least one measured actual membrane state value. The detecting device is hence used to detect at least one of the actual membrane state values of the actual membrane state. For example, only one of the actual membrane state values is detected or measured. However, preferably at least two, in particular exactly two, of the actual membrane state values are detected using the detecting device. These are in particular the actual membrane position and the actual membrane acceleration.

According to another embodiment of the invention, a distance sensor, in particular an optical distance sensor, preferably a laser distance sensor, is used as detecting device for detecting the actual membrane position. The distance sensor has a stationary location so as to be capable of detecting its distance from the membrane with sufficient accuracy. The deflection of the membrane and therefore the actual membrane position can subsequently be determined from the distance measured by the distance sensor. Preferably, the optical distance sensor is used as the distance sensor, because the distance can then be sensed without physical contact. The optical distance sensor includes a light source and a light sensor, wherein the light source is directed onto the membrane and the light sensor is arranged so as to detect the light reflected from the membrane of the light source. The optical distance sensor measures the distance, for example by measuring a transit time of the light emitted from the light source, for example by determining a phase angle and/or by triangulation. The latter is particularly preferred when the optical distance sensor is embodied as a laser distance sensor (laser triangulation). The laser distance sensor is, in accordance with its name, equipped with a laser emitter operating as a light source.

According to another embodiment of the invention, an acceleration sensor disposed on the membrane, in particular a piezo-electronic sensor or a MEMS sensor is used for detecting the actual membrane acceleration. In this way, the actual membrane acceleration can be determined directly, i.e. not only indirectly from at least one other actual membrane state value. For measuring the actual membrane acceleration, the acceleration sensor must be arranged directly on the membrane so as to move together with the latter in accordance with the driving signal. In principle, any type of acceleration sensor may be used. However, particularly preferred is a piezo-electronic sensor or a MEMS sensor (MEMS: micro-electro-mechanical system). Of course, a plurality of acceleration sensors may also be arranged on the membrane. In addition, at least one additional acceleration sensor may be provided on a cage of the loudspeaker or on an element that is held stationary with respect to the cage. This additional acceleration sensor is therefore used to measure an acceleration of the cage and can be used to correct the actual membrane acceleration determined with the aforementioned acceleration sensor. This is particularly useful when the loudspeaker is located in an accelerated frame of reference, as is the case for example with an arrangement in a motor vehicle. The total acceleration of the loudspeaker can be determined with the at least one additional acceleration sensor. The actual membrane acceleration is now determined for example by subtracting the total acceleration of the initially measured actual membrane acceleration.

According to another embodiment of the invention, the not-measured actual membrane state value may be determined from the at least one measured actual membrane state value. As already stated above, not all actual membrane state values of actual membrane states need to be determined, i.e. measured. Instead, only some of the actual membrane state values may be measured and the not-measured actual membrane state values may be calculated therefrom. For this purpose, for example a corresponding system of differential equations is solved. However, as a basic rule, the accuracy of actual membrane states is the greater the more actual membrane state values are detected. Particularly preferred, two of the actual membrane state values, namely the actual membrane position and actual membrane acceleration, are detected and actual membrane velocity is then determined from these values. This is possible with relatively little computational effort. At the same time, the actual membrane state determined in this way is highly accurate.

According to another embodiment of the invention, for determining the driving signal, a target membrane state in the form of a target membrane position, a target membrane velocity or a target membrane acceleration, which is determined from an input signal of the loudspeaker device, is used in addition to the actual membrane state. The input signal, for example from a sound source or the like, is therefore provided to the loudspeaker device. This sound source may be, for example, a component of the stereo system or the car-fidelity system. The target membrane state is now determined from this input signal. The target membrane position, the target membrane velocity or the target membrane acceleration is used as the target membrane state, i.e. only a single one of these target membrane state variables. This target membrane state is then compared with the actual membrane state or with the actual membrane state value corresponding of the target membrane state value. The result of this comparison is a driving signal that is applied to the voice coil of the loudspeaker. Preferably, the target membrane acceleration serves as the target membrane state. In this case, for example, a difference between the target membrane acceleration and the actual membrane acceleration, and additionally the actual membrane position, the actual membrane velocity and the actual membrane acceleration are input variables in a relationship that produces the driving signal as an output variable.

According to another embodiment of the invention, a driving voltage may be used as a driving signal, which is determined from the relationship

$$U ( t ) = \frac{α}{Δ t} ( {α}_{target} ( t ) - {α}_{actual} ( t ) ) + {βα}_{actual} ( t ) + γ {v}_{actual} ( t ) + δ {x}_{actual} ( t )$$

$$wherein$$

$$α = \frac{mL}{Bl} , \\ β = \frac{mL}{Bl} ( \frac{R}{L} + \frac{{ω}_{0}}{Q} ) , \\ γ = \frac{mL}{Bl} ( \frac{R {ω}_{0}}{QL} + {ω}_{0}^{2} + \frac{{( Bl )}^{2}}{mL} ) , \\ as well as$$

$$δ = \frac{mL}{Bl} \frac{R {ω}_{0}^{2}}{L} ,$$

and

wherein x_{actual} is the actual membrane position, U(t) is the voltage applied to the loudspeaker, m is the mass of the membrane, L is the inductance of the voice coil, R is the resistance of the loudspeaker, ω₀ is the natural frequency or the resonance frequency of the loudspeaker, Q is the quality-factor of the loudspeaker, BI the conversion ratio of electric current into power, Δt is a time interval, a_{target} is the target membrane acceleration, a_{actual} is the actual membrane acceleration, v_{actual} is the actual membrane velocity, x_{actual} the actual membrane position and t is time. The time interval Δt is equal to the inverse of the sampling frequency fₛ. Of course, the general relationship applies

a(t)=\dot{v}(t)=\ddot{x}(t).

In the described embodiment, the driving voltage U(t) which is time-dependent is thus used as the driving signal. The above-mentioned relationship is derived from the equations

$$\frac{{\partial }^{2} x}{\partial {t}^{2}} + \frac{{ω}_{0}}{Q} \frac{\partial x}{\partial t} + {ω}_{0}^{2} x = \frac{Bl}{m} I ( t )$$

$$and$$

$$RI ( t ) + L \frac{\partial I}{\partial T} + Bl \frac{\partial x}{\partial t} = U ( t ) ,$$

wherein I (t) is the magnitude of the current flowing through the loudspeaker. When these equations are combined, the relation becomes

$$α \frac{{\partial }^{3} x}{\partial {t}^{3}} + β \frac{{\partial }^{2} x}{\partial {t}^{2}} + γ \frac{\partial x}{\partial t} + δ x = U ( t ) ,$$

when using the above-defined values α, β, γ and δ.

The invention further relates to a loudspeaker device, in particular for implementing the method according to one or more of the preceding claims, with at least one loudspeaker, wherein a detecting device for detecting at least one actual membrane state value of a membrane of the loudspeaker is provided. The loudspeaker system shall here be configured to determine an actual membrane state of the membrane, including the actual membrane state values, namely the actual membrane position, the actual membrane velocity and the actual membrane acceleration, from the at least one measured actual membrane state value and to directly use the actual membrane state for determining a driving signal applied to the membrane voice coil of the loudspeaker operatively connected to the membrane. In addition to the loudspeaker, the loudspeaker device may include a control unit which is used to determine the driving signal, in particular from the input signal by taking into account the actual membrane state.

The invention further relates to a device for noise compensation, with a sound detecting device, a control unit and a loudspeaker device, wherein the sound detecting device detects a sound signal from a sound source and the control unit determines from the sound signal an anti-sound signal which is supplied to the loudspeaker device as an input signal. The loudspeaker device is hereby configured in accordance with the foregoing description, or for performing the above-described method. With the device, the sound generated by the sound source is at least for the most part compensated by emitting anti-sound or the anti-sound signal with loudspeaker device. For this purpose, the sound of the sound source is detected by the sound detecting device as a sound signal. The control unit analyzes the sound signal and generates the anti-sound signal which is then provided or supplied to the loudspeaker device. Especially when the loudspeaker device is employed in this manner, it is very important that not only the frequency profile, but also the phase profile of the anti-sound signal can be accurately reproduced. Therefore, the above-described loudspeaker device or the corresponding method is used.

According to another embodiment of the invention, the sound source may be an internal combustion engine. The internal combustion engine is normally associated with a motor vehicle. The goal is hereby to reduce the sound or its intensity in an interior compartment and/or an exterior space of the vehicle, i.e. in a vicinity of the internal combustion engine. The device for noise compensation is used for this purpose. In particular, this device is used for sound attenuation in or parallel to an exhaust system of the internal combustion engine. In this case, anti-sound is selectively emitted or introduced into the exhaust system. This anti-sound is to be destructively superimposed on the end-of-pipe noise emitted from the exhaust system. It is therefore advantageous to use a sound source, wherein both the amplitude and the phase or phase shift of the sound can be adjusted in real time. In other words, it must be possible to specify the position profile, the velocity profile and/or the acceleration profile of the sound-generating membrane. For this reason, the above-described sound detecting device or the corresponding method is used.

Accordingly, the loudspeaker of the loudspeaker device has the detecting device that detects the actual membrane position, the actual membrane velocity and/or the actual membrane acceleration and passes it to the control unit. Furthermore, the anti-sound signal is supplied to the control device as an input signal. The input signal specified here the target membrane position, the target membrane velocity or the target membrane acceleration. The control unit then calculates the driving signal supplied to the loudspeaker that results in the desired profile of actual membrane state by using the input variables and typical loudspeaker characteristic values, such as the electrical resistance, the inductance, the quality factor, the mass of the membrane, the natural frequency and the conversion ratio. The determined driving signal is transmitted to the loudspeaker or the voice coil, for example, via an amplifier. Because usually only not all the actual membrane state values of actual membrane state are measured, the remaining actual membrane state values, i.e. the values not specifically determined, are determined by the control unit from the measured actual membrane state values, for example by solving differential equations that describe the movement of the membrane. Control frequencies up to 50 kHz or higher can be realized in this way.

Lastly, the invention relates to an internal combustion engine of a motor vehicle having a device for noise compensation in accordance with the foregoing description, wherein the internal combustion engine is the sound source.

The invention will be explained in more detail with reference to the exemplary embodiments shown in the drawings, without limiting the scope of the invention. The drawings show in:

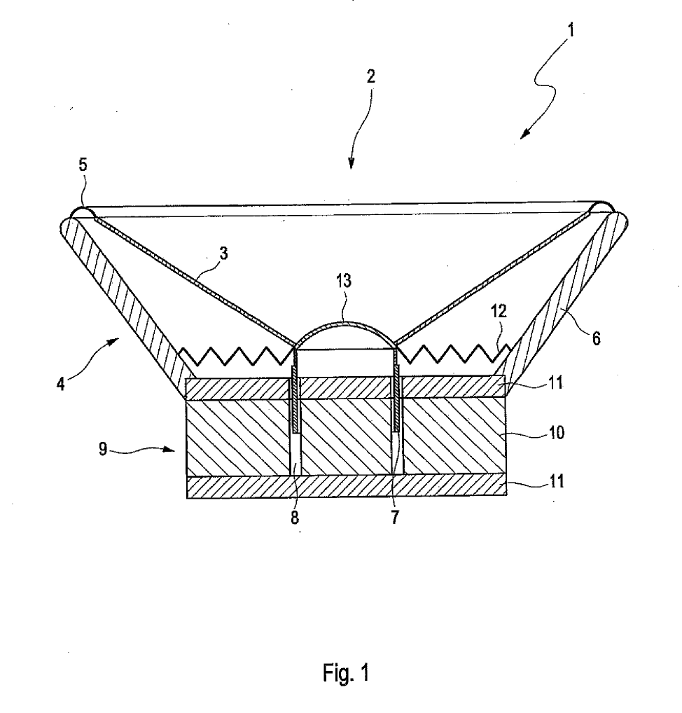

FIG. 1 a cross section through a loudspeaker a loudspeaker device, and

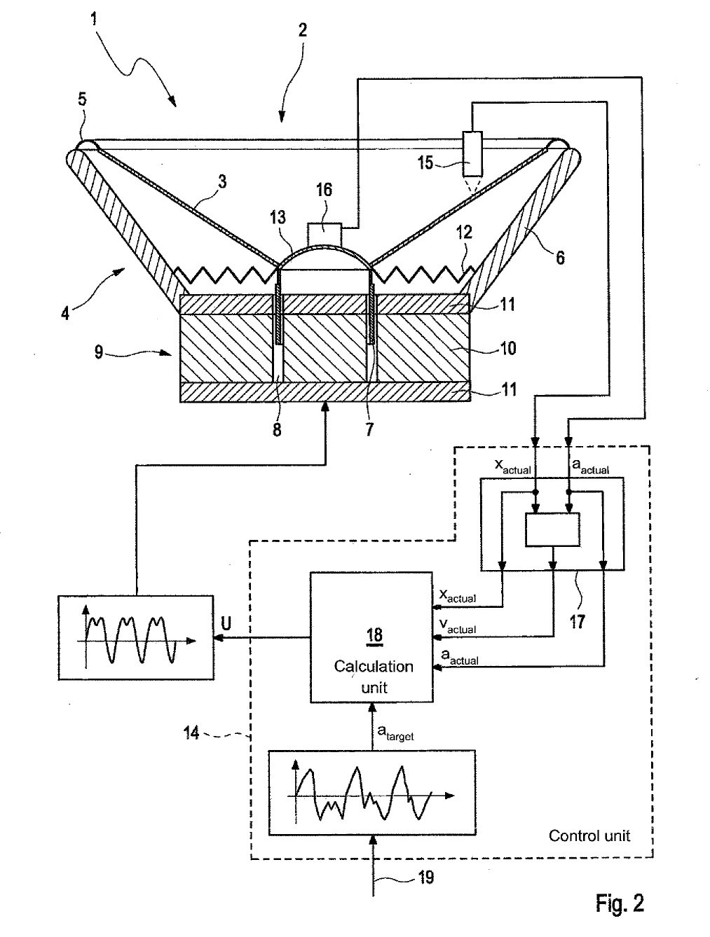

FIG. 2 a schematic diagram of the loudspeaker device.

FIG. 1 shows a portion of a loudspeaker device 1, namely a loudspeaker 2. The loudspeaker 2 is composed of a membrane 3, which is suspended for oscillating movement with respect to a housing 4 of the loudspeaker 2. This is realized in particular by means of a corrugation 5 that secures the membrane 3 to a cage 6 of the housing 4. The loudspeaker 2 and the membrane 3, respectively, are excited via a voice coil 7 arranged in a coil guide 8 of a magnetic device 9. The magnetic device 9 includes at least one permanent magnet 10 and pole plates 11 covering the magnet 10. The first membrane 3 is returned to its rest position by means of a spider 12 when the voice coil 7 is not energized. The voice coil 7 engages with an edge of a central opening of the membrane 3, which is sealed with a cover cap 13.

Such a loudspeaker 2 is inserted into the loudspeaker device 1 shown in FIG. 2. The loudspeaker device 1 has in addition to the loudspeaker 2 a control unit 14, a first detecting device 15 and a second detecting device 16. The first detecting device 15 is constructed as a distance sensor, preferably as a laser distance sensor. The first detecting device 15 is arranged stationarily with respect to the housing 4 of the loudspeaker 2 and allows a measurement of the actual membrane position. Conversely, the second detecting device 16 is an acceleration sensor for measuring an actual membrane acceleration. The second detecting device 16 is for example disposed on the cover cap 13, which is displaceable together with the membrane 3. Both the actual membrane position x_{actual} determined with the first detecting device 15 and the actual membrane acceleration a_{actual} determined with the second detecting device 16 are supplied to the control unit 14, which initially determines the actual membrane velocity v_{actual} from the actual membrane position x_{actual} and the actual membrane acceleration a_{actual}, for example by using a calculation unit 17.

The actual membrane position x_{actual}, the actual membrane velocity v_{actual} and the actual membrane acceleration a_{actual} together form an actual membrane state, which is supplied by the calculation unit 17 to an additional calculation unit 18. The actual membrane state thus represents an input variable for the calculation unit 18. Moreover, an input signal is supplied to the loudspeaker device 1 via an input 19. The input signal is first converted into a target membrane state which should be available, example, as a target membrane position x_{target}, a target membrane velocity v_{target} or a target membrane acceleration a_{target}. In the present example, the target membrane acceleration a_{target} is used as the target membrane state, which is also supplied as an input variable to the calculation unit 18. The calculation unit 18 calculates from these input variables, i.e. the target membrane state and the actual membrane state, a driving signal in the form of a driving voltage U, which is supplied by the control unit 14 to the loudspeaker 2 and the voice coil 7, respectively. The input signal can be faithfully reproduced with such a loudspeaker device 1. In particular, not only the frequency but also the phase of the input signal is faithfully reproduced.

The loudspeaker device 1 is used for example in the context of a device for noise compensation, which additionally has an unillustrated sound sensing device which senses a sound signal of a sound source, such as an internal combustion engine. A control unit of the device (also not shown) determines from this sound signal an anti-sound signal, which is then supplied to the loudspeaker device 1 as an input signal via the input 19. The sound signal is then at least partially cancelled by outputting the anti-sound signal with the loudspeaker device 1.

### LIST OF REFERENCES

1 Loudspeaker device
2 Loudspeaker
3 Membrane
4 Housing
5 Corrugation
6 Cage
7 Voice coil
8 Coil guide
9 Magnetic device
10 Permanent magnet
11 Pole plate
12 Spider
13 Cover cap
14 Control unit
15 1. Detecting device
16 2. Detecting device
17 Calculation unit
18 Calculation unit
19 Input

1-10. (canceled)

11. A method for operating a loudspeaker device having at least one loudspeaker, the method comprising:
detecting with a detecting device at least one actual membrane state value of a membrane of the loudspeaker,
determining from the at least one actual membrane state value an actual membrane state of the membrane, said actual membrane state comprising an actual membrane position, an actual membrane velocity and an actual membrane acceleration, and
determining from the actual membrane state directly a driving signal to be applied to a voice coil of the loudspeaker wherein the voice coil is operatively connected the membrane, wherein the driving signal is a driving voltage determined from a relationship
$$U ( t ) = \frac{α}{Δ t} ( {α}_{target} ( t ) - {α}_{actual} ( t ) ) + {βα}_{actual} ( t ) + γ {v}_{actual} ( t ) + δ {x}_{actual} ( t ) , \\ wherein$$
$$α = \frac{mL}{Bl} , \\ β = \frac{mL}{Bl} ( \frac{R}{L} + \frac{{ω}_{0}}{Q} ) , \\ γ = \frac{mL}{Bl} ( \frac{R {ω}_{0}}{QL} + {ω}_{0}^{2} + \frac{{( Bl )}^{2}}{mL} ) , \\ and$$
$$δ = \frac{mL}{Bl} \frac{R {ω}_{0}^{2}}{L} ,$$
wherein x_{actual} is the actual membrane position, U(t) is the driving voltage applied to the loudspeaker, m is a mass of the membrane, L is an inductance of the voice coil, R is a resistance of the loudspeaker, ω₀ is a natural frequency of the loudspeaker, Q is a quality-factor of the loudspeaker, BI is a conversion ratio of electric current into power, Δt is a time interval, a_{target} is a target membrane acceleration, a_{actual} is the actual membrane acceleration, v_{actual} is the actual membrane velocity, x_{actual} is the actual membrane position and t is time.

12. The method of claim 11, wherein at least one of the actual membrane position, the actual membrane velocity and the actual membrane acceleration are used as the at least one measured actual membrane state value.

13. The method of claim 11, wherein the detecting device detecting the actual membrane position comprises a distance sensor.

14. The method of claim 13, wherein the distance sensor is an optical distance sensor.

15. The method of claim 14, wherein the optical distance sensor is a laser distance sensor.

16. The method of claim 11, wherein the detecting device detecting the actual membrane acceleration is an acceleration sensor arranged on the membrane.

17. The method of claim 16, wherein the acceleration sensor is a piezo-electronic sensor or a MEMS sensor.

18. The method of claim 11, wherein when an actual membrane state value is not detected with the detection device, this not-detected actual membrane state value is determined from the at least one actual membrane state value that is detected with the detection device.

19. The method of claim 11, wherein the driving signal is determined, in addition to the actual membrane state, from a target membrane state which is determined from an input signal of the loudspeaker system and which comprises a target membrane position, a target membrane velocity, or a target membrane acceleration.

20. A loudspeaker device, comprising
at least one loudspeaker, and
a detecting device for detecting at least one actual membrane state value of a membrane of the at least one loudspeaker, said at least one actual membrane state value comprising an actual membrane position, an actual membrane velocity and an actual membrane acceleration,
wherein the loudspeaker device is configured
to supply a driving signal in form of a driving voltage to a voice coil of the at least one loudspeaker, the voice coil being operatively connected to the membrane,
to determine from the at least one measured actual membrane state value an actual membrane state of the membrane, and
to use the actual membrane state directly to determine the driving signal from the relationship
$$U ( t ) = \frac{α}{Δ t} ( {α}_{target} ( t ) - {α}_{actual} ( t ) ) + {βα}_{actual} ( t ) + γ {v}_{actual} ( t ) + δ {x}_{actual} ( t ) , \\ wherein$$
$$α = \frac{mL}{Bl} , \\ β = \frac{mL}{Bl} ( \frac{R}{L} + \frac{{ω}_{0}}{Q} ) , \\ γ = \frac{mL}{Bl} ( \frac{R {ω}_{0}}{QL} + {ω}_{0}^{2} + \frac{{( Bl )}^{2}}{mL} ) , \\ and$$
$$δ = \frac{mL}{Bl} \frac{R {ω}_{0}^{2}}{L} ,$$
wherein x_{actual} is the actual membrane position, U(t) is the driving voltage applied to the loudspeaker, m is a mass of the membrane, L is an inductance of the voice coil, R is a resistance of the loudspeaker, ωₒ is a natural frequency of the loudspeaker, Q is a quality-factor of the loudspeaker, BI is a conversion ratio of electric current into power, Δt is a time interval, a_{target} is a target membrane acceleration, a_{actual} is the actual membrane acceleration, v_{actual} is the actual membrane velocity, x_{actual} is the actual membrane position and t is time.

21. An apparatus for noise compensation, comprising
a sound detecting device detecting a sound signal from a sound source,
a loudspeaker device having at least one loudspeaker,
a control unit determining from the detected sound signal an anti-sound signal which is supplied to the loudspeaker device as an input signal, and
a detecting device for detecting at least one actual membrane state value of a membrane of the loudspeaker device, said at least one actual membrane state value comprising an actual membrane position, an actual membrane velocity and an actual membrane acceleration,
wherein the loudspeaker device is configured
to supply a driving signal in form of a driving voltage to a voice coil of the at least one loudspeaker, the voice coil being operatively connected to the membrane,
to determine from the at least one measured actual membrane state value an actual membrane state of the membrane, and
to use the actual membrane state directly to determine the driving signal from the relationship
$$U ( t ) = \frac{α}{Δ t} ( {α}_{target} ( t ) - {α}_{actual} ( t ) ) + {βα}_{actual} ( t ) + γ {v}_{actual} ( t ) + δ {x}_{actual} ( t ) , \\ wherein$$
$$α = \frac{mL}{Bl} , \\ β = \frac{mL}{Bl} ( \frac{R}{L} + \frac{{ω}_{0}}{Q} ) , \\ γ = \frac{mL}{Bl} ( \frac{R {ω}_{0}}{QL} + {ω}_{0}^{2} + \frac{{( Bl )}^{2}}{mL} ) , \\ and$$
$$δ = \frac{mL}{Bl} \frac{R {ω}_{0}^{2}}{L} ,$$
wherein x_{actual} is the actual membrane position, U(t) is the driving voltage applied to the loudspeaker, m is a mass of the membrane, L is an inductance of the voice coil, R is a resistance of the loudspeaker, ω₀ is a natural frequency of the loudspeaker, Q is a quality-factor of the loudspeaker, BI is a conversion ratio of electric current into power, Δt is a time interval, a_{target} is a target membrane acceleration, a_{actual} is the actual membrane acceleration, v_{actual} is the actual membrane velocity, x_{actual} is the actual membrane position and t is time.

22. The apparatus of claim 21, wherein the sound source is an internal combustion engine.
